(19) United States
(12) Patent Application Publication
(10) Pub. No.: US 2025/0200290 A1
(43) Pub. Date: Jun. 19, 2025

(54) METHOD AND SYSTEM FOR RECOMMENDATION OF SUITABLE ASSETS USING LARGE LANGUAGE MODEL (LLM)

(71) Applicant: Quantiphi, Inc, Marlborough, MA (US)

(72) Inventors: Dagnachew Birru, Marlborough, MA (US); Ankit Prakash, Mumbai (IN); Jasprit Kaur, Mumbai (IN); Ashwin Sanjeevan, Mumbai (IN); Sriram Natarajan, Mumbai (IN)

(73) Assignee: Quantiphi, Inc, Marlborough, MA (US)

(21) Appl. No.: 18/389,749

(22) Filed: Dec. 19, 2023

(51) Int. Cl. G06F 40/40; G06F 16/33

(52) U.S. Cl. CPC G06F 40/40; G06F 16/33

(57) ABSTRACT

The present disclosure provides a method for recommendation of suitable assets using Large Language Model (LLM), method comprising receiving descriptors for each asset from amongst plurality of assets; generating embeddings for each asset from amongst plurality of assets, by employing LLM; creating database of assets by storing generated embeddings for each asset from amongst plurality of assets in database; receiving user query pertaining to request for recommendation to solve enterprise problem; generating cosine similarity scores, wherein each cosine similarity score is generated between user query and corresponding generated embedding for given asset stored in database of assets; identifying predefined number of similar assets from amongst database of assets, based on highest cosine similarity scores; constructing optimal prompt based on identified predefined number of similar assets and user query; and prompting LLM, using constructed optimal prompt for generating response as recommendation of identified predefined number of similar assets as suitable assets for solving user query.

### FIELD OF TECHNOLOGY

The present disclosure generally relates to machine learning. Specifically, the present disclosure relates to a method and a system for recommendation of suitable assets using a Large Language Model (LLM).

### BACKGROUND

Conventionally, tasks related to different technologies require use of correct software tools, applications and modules for the execution of the tasks. However, finding these correct software tools, applications and modules require a significant amount of time and resources, which makes the process of finding solutions for these tasks an unpleasant and cumbersome process.

Moreover, even when the correct software tools, applications and modules for a given task have been identified by a user, another user who wants to solve the given task requires to repeat the whole process of finding the correct software tools, applications and modules for the given task. Thus, there exists a need for automating the process of finding the correct software tools, applications and modules required to solve the given task.

Further limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides for a method and a system for recommendation of suitable assets using a Large Language Model (LLM). The present disclosure seeks to provide a solution to the existing problem of how to simplify and automate a process of finding the suitable assets for an enterprise problem. An aim of the present disclosure is to provide a solution that overcomes at least partially the problems encountered in the prior art and provide an improved method and system for recommendation of suitable assets using a Large Language Model (LLM) which simplifies and automates the process of finding the suitable assets for an enterprise problem.

In one aspect, the present disclosure provides a method for recommendation of suitable assets using a Large Language Model (LLM). The method comprises receiving descriptors for each asset from amongst a plurality of assets. Moreover, the method comprises generating embeddings for each asset from amongst the plurality of assets, by employing the LLM, based on the provided descriptors of each asset from amongst the plurality of assets. Furthermore, the method comprises creating a database of assets by storing the generated embeddings for each asset from amongst the plurality of assets in the database. Furthermore, the method comprises receiving a user query pertaining to a request for recommendation to solve an enterprise problem. Furthermore, the method comprises generating cosine similarity scores, wherein each cosine similarity score is generated between the user query and a corresponding generated embedding for a given asset stored in the database of assets. Furthermore, the method comprises identifying a predefined number of similar assets from amongst the database of assets, based on highest cosine similarity scores. Furthermore, the method comprises constructing an optimal prompt based on the identified predefined number of similar assets and the user query. Furthermore, the method comprises prompting the LLM, using the constructed optimal prompt for generating a response as a recommendation of the identified predefined number of similar assets as the suitable assets for solving the enterprise problem in the user query.

Beneficially, the embodiments of the present disclosure provide a simplified, efficient and automated method that correctly recommends the suitable assets using the Large Language Model (LLM). The use of the disclosed method removes a need for human intervention and simplifies the process of recommendation of the suitable assets. Moreover, the disclosed method eliminates a need for repeating the process of identifying the suitable assets for the same enterprise problem again and again. Furthermore, the disclosed method has significantly increased a speed of recommending the suitable assets for the enterprise problem.

In another aspect, the present disclosure provides a system for recommendation of suitable assets using a Large Language Model (LLM). The system comprises a processor. The processor is configured to receive descriptors for each asset from amongst a plurality of assets. Moreover, the processor is configured to generate embeddings for each asset from amongst the plurality of assets, by employing the LLM, based on the provided descriptors of each asset from amongst the plurality of assets. Furthermore, the processor is configured to create a database of assets by storing the generated embeddings for each asset from amongst the plurality of assets in the database. Furthermore, the processor is configured to receive a user query pertaining to a request for recommendation to solve an enterprise problem. Furthermore, the processor is configured to generate cosine similarity scores, wherein each cosine similarity score is generated between the user query and a corresponding generated embedding for a given asset stored in the database of assets. Furthermore, the processor is configured to identify a predefined number of similar assets from amongst the database of assets, based on highest cosine similarity scores. Furthermore, the processor is configured to construct an optimal prompt based on the identified predefined number of similar assets and the user query. Furthermore, the processor is configured to prompt the LLM, using the constructed optimal prompt for generating a response as a recommendation of the identified predefined number of similar assets as the suitable assets for solving the user query.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIGS. 1A and 1B collectively are a flowchart of a method for recommendation of suitable assets using a Large Language Model (LLM), in accordance with an embodiment of the present disclosure;

FIG. 2 is a flowchart depicting of an exemplary scenario depicting steps for creating a database of assets by storing generated embeddings for each asset from amongst a plurality of assets in the database, in accordance with an embodiment of the present disclosure; and

FIG. 3 is a block diagram of a system for recommendation of suitable assets using a Large Language Model (LLM), in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

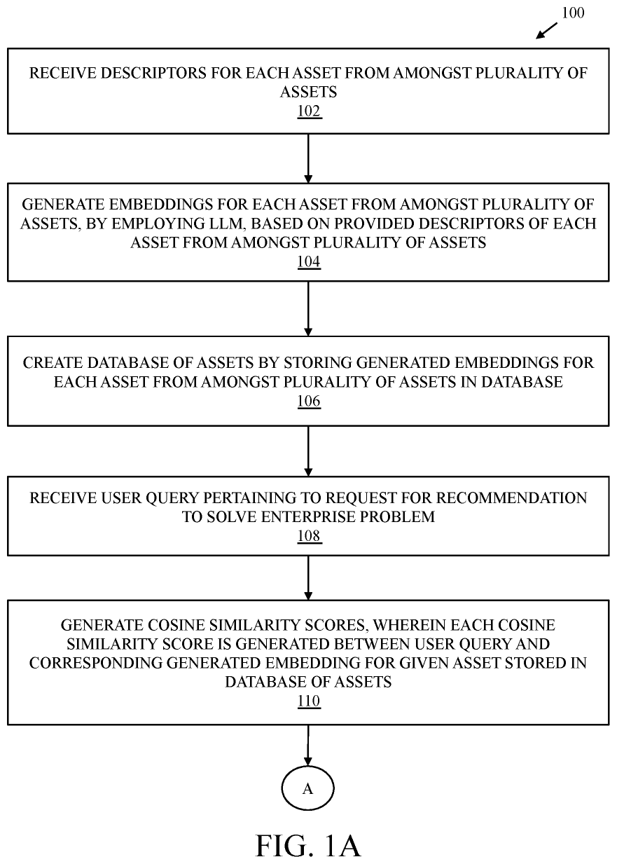

FIGS. 1A and 1B collectively are a flowchart of a method for recommendation of suitable assets using a Large Language Model (LLM), in accordance with an embodiment of the present disclosure. The method 100 comprises steps from 102 to 116.

Herein, the LLM refers to a form of artificial intelligence model which is designed to process, understand, and generate human language. Known Large Language Models may be used in the present invention. Notably, the LLM is capable of learning patterns, structures and nuances of the human language which enables the LLM to develop an advanced understanding of the human language and generate logical text in the form of human language. It will be appreciated that the LLM relies on use of deep learning techniques such as use of transformers that excels in understanding long-range dependencies in any sequence of data, and hence make the LLM more equipped for an advanced processing, understanding and generation of the human language. Herein, the term suitable assets refers to software tools and applications that are most suited to solve a given enterprise problem related to any technological domain. The method involves identifying suitable assets from the plurality of assets that are available, based on their compatibility and utility with the enterprise problem to be solved. The LLM analyzes and evaluates the characteristics and functionalities of the plurality of assets to determine their suitability. By employing this method, users can efficiently discover and select suitable assets that align with the specific technological needs of the enterprise problem, thereby enhancing problem-solving capabilities and optimizing resource utilization.

At step 102, descriptors are received for each asset from amongst a plurality of assets. Herein the term descriptors refer to those attributes that aid in providing insight into capabilities of each asset. Notably, receiving the descriptors for each assets from amongst the plurality of assets enable to accurately determine the asset type and capabilities, thereby facilitating effective asset management and utilization.

In an implementation, the plurality of assets comprises at least one of: a machine learning model, a login module, a software, an object detection model, and the like. Herein, the term machine learning model refers to an algorithm that is designed to learn patterns and make predictions and decisions based on given data. Herein, the term login module refers to a model or algorithm that verifies or authenticates an identity of users. Herein, the term object detection module refers to an algorithm that is used to locate and identify objects within an image or video stream. The object detection module is widely used in applications such as autonomous vehicles, surveillance, facial recognition, and many more. Optionally, the plurality of assets also comprises at least one of: code utilities (for example, connectors, scripts, libraries, and the like), platform utilities (for example, PaaC, DevOps pipelines, laaC, and the like), testing utilities (for example, test automation scripts, security testing script, and the like), demos (for example, dashboards, webpages, websites, and the like), containers (for example, docker file, docker image, and the like), technical flow diagrams (for example, architecture diagrams, flowcharts, deployment, and the like), platforms, pre-trained models (for example, tensorflow models, pytorch models, and the like), annotated datasets (for example, unstructured data, structured data, and the like), miscellaneous, and the like. A technical effect of the plurality of assets comprises at least one of: the machine learning model, the login model, the software, the object detection model, and the like is that the plurality of assets are available for a wide range of different technological domains and applications.

In an implementation, the descriptors of each asset from amongst the plurality of assets comprises: an asset title, an asset description, asset metadata. The inclusion of asset titles allows for quick identification of assets, while asset descriptions provide additional information about the assets. Furthermore, asset metadata enhances the searchability and accessibility of the assets. A technical effect is that the method improves the effectiveness and efficiency of asset identification and categorization within the plurality of assets.

At step 104, embeddings are generated for each asset from amongst the plurality of assets, by employing the LLM, based on the provided descriptors of each asset from amongst the plurality of assets. Herein, the term embeddings refers to vector representations of the descriptors for each asset from amongst the plurality of assets. The technical effect is that generating the embeddings for each asset from amongst the plurality of assets, advantageously, reduces size of required memory for storing the information of the descriptors for each asset. By employing the LLM, the method ensures accurate and efficient generation of embeddings. The use of embeddings allows for improved management, retrieval, and analysis of each asset leading to enhanced performance and efficiency in identifying the suitable assets.

In an implementation, the LLM used for implementing the step of generating embeddings for each asset from amongst the plurality of assets, is a text_embedding_ada model. Herein, term “generating embeddings” refers to a process of converting complex high-dimensional data to a low-dimensional data while preserving an essential structure of a given data. It will be appreciated that the text_embedding_ada is a well-known in the art model for generating the embeddings. The text_embedding_ada model uses transformer based architecture for generating the embeddings for each asset from amongst the plurality of assets. Notably, the text_embedding_ada model is a pretrained model that is trained on large corpuses of open source data. A technical effect of using text_embedding_ada model is that the generated embeddings are accurate, efficient, and reliable to use.

At step 106, a database is created of assets by storing the generated embeddings for each asset from amongst the plurality of assets in the database. Herein, the term database refers to a structured and organized collection of data of the generated embeddings for each asset from amongst the plurality of assets. Notably, the creation of the database provides a form of a digital library or storage unit from which information related to any asset can be fetched and utilized whenever required. It will be appreciated that the storing of the generated embeddings for each asset from amongst the plurality of assets significantly increases the number of assets for which the generated embeddings can be stored in the database as the generated embeddings require less memory for storage.

In an implementation, the generated embeddings for each asset from amongst the plurality of assets are stored in the database in an indexed form. A technical effect is that the storage of the generated embeddings in the database in the indexed form enables quick identification and retrieval of specific assets, facilitating streamlined data processing and analysis. Advantageously, by storing the embeddings in an indexed form, the method optimizes the utilization of the database resources and enhances an overall efficiency of management and retrieval of the plurality of assets.

At step 108, a user query is received pertaining to a request for recommendation to solve an enterprise problem. Herein, the term enterprise problem refers to certain technology related tasks that require different assets as a solution to the enterprise problem (i.e., to execute the task in the enterprise problem using the suitable assets). Notably, the suitable assets are these assets which provide the solution for the enterprise problem. For example, the enterprise problem may be recognition of a given action in a given sport, or monitoring of people in a warehouse. Notably, enterprise problems may be solved by using those suitable assets that have been previously used for other enterprise problems. It will be appreciated that the user query contains information related to what is the enterprise problem that a user wants to solve. In an example, the user query that is received is “knowledge graph construction” for construction of a knowledge graph. In another example, the user query that is received is “object detection model deployment” for deployment of an object detection module.

In an implementation, the user query is received from a user device associated with a user. Herein, the user device refers to any device associated with the user which has computational capabilities. Optionally, the user device is one of: a mobile phone, a tablet, a computer, and the like. A technical effect is that the user is able to provide the user query easily and conveniently.

At step 110, cosine similarity scores are generated, wherein each cosine similarity score is generated between the user query and a corresponding generated embedding for a given asset stored in the database of assets. Herein, the term cosine similarity scores refer to a type of similarity scores that are generated between the corresponding generated embedding for the given asset and the user query, where the cosine similarity scores indicate the similarity between the corresponding generated embedding for the given asset and the user query. Notably, a separate cosine similarity score for each of the given asset from amongst the database of assets. It will be appreciated that higher the cosine similarity score for the given asset, more suitable the given asset is for the enterprise problem.

At step 112, a predefined number of similar assets are identified from amongst the database of assets, based on highest cosine similarity scores. Herein, the plurality of assets are arranged in a descending order based on the cosine similarity scores for each asset in the database of assets. Subsequently, the cosine similarity score for each asset in the database of assets is analyzed to determine which assets in the database of assets are the predefined number of assets which have the highest cosine similarity scores. Herein, the term highest cosine similarity scores refers to those cosine similarity scores of the predefined number of assets which have a higher value than the cosine similarity scores of remaining assets in the database of assets. For example, top 10 assets in the database of assets having the highest cosine similarity scores are identified as the predefined number of similar assets from amongst the database of assets.

At step 114, an optimal prompt is constructed based on the identified predefined number of similar assets and the user query. Herein, the term optimal prompt refers to an instruction designed for the LLM to instruct the LLM to use provided context and provide the recommendation within the provided context only. Notably, the provided context comprises the user query and the identified predefined number of similar assets. It will be appreciated that language processing capabilities of the LLM is utilized to construct the optimal prompt. Optionally, the optimal prompt also comprises a problem and solution example, to enable better recommendation of the suitable assets. For example, the optimal prompt includes a problem of “how can a database be applied on K8s using IAAS?” and a corresponding solution which is “The Elasticsearch & Kibana on Kubernetes asset can be used for deploying databases on K8s using IAAS. This asset contains Terraform script to set up the private GKE cluster and deploy the Elasticsearch and Kibana onto the cluster with an ingress load balancer to expose the Elasticsearch and Kibana application.

In an implementation, the step of prompting the LLM, using the constructed optimal prompt, for recommending suitable assets for solving the enterprise problem, is implemented by using a technique of few-shot prompting. Herein the term few-shot prompting refers to a technique used in instruction tuning the LLM that allows the LLM to perform a task with minimal training examples or examples that are provided in a given prompt. A technical effect of using the few-shot prompting technique is that minimal efforts are required in prompting the LLM for recommending suitable assets for solving the enterprise problem.

At step 116 the LLM is prompted, using the constructed optimal prompt for generating a response as a recommendation of the identified predefined number of similar assets as the suitable assets for solving the user query. In this regard, the solution to the enterprise problem is provided in form of the recommendation asking the user to make use of the predefined number of similar assets that are identified as the suitable assets for the enterprise problem in the user query. The method is able to achieve successful utilization of the constructed optimal prompt and provide accurate recommendations for the enterprise problem in the user query. For example, the response that is generated for the user query “recognize a given action in a given sport” is “The proprietary Object Detection Training asset, the Object Detection Model Deployment and the proprietary Object Detection Inference asset can be used to build a solution for player recognition in sports. These assets provide the necessary tools for training an object detection model on the proprietary DGX platform using proprietary TLT, and for running an end-to-end object detection inference using proprietary Deepstream on the DGX platform. Additionally, the Dockerfile included in these modules contains all the necessary dependencies for launching a container to run the model training end-to-end”.

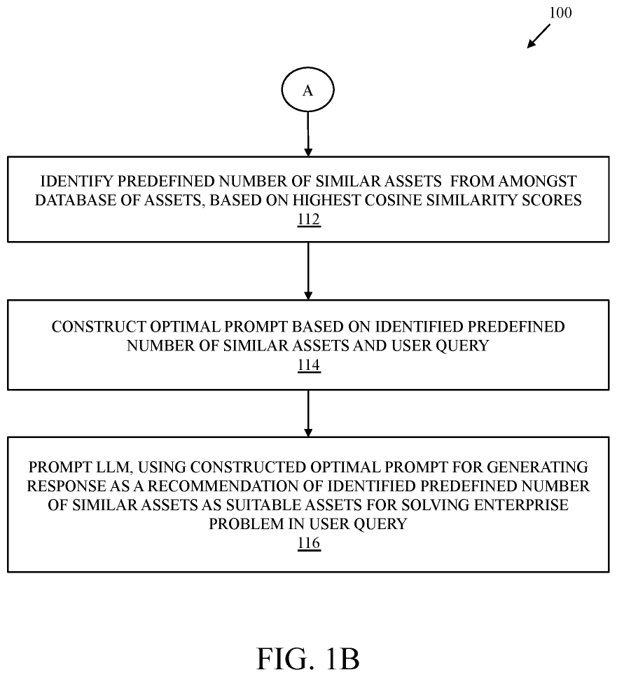

FIG. 2 is a flowchart depicting of an exemplary scenario depicting steps for creating a database of assets by storing generated embeddings for each asset from amongst a plurality of assets in the database, in accordance with an embodiment of the present disclosure. At step 202, the plurality of assets and corresponding descriptor for each asset from amongst the plurality of assets are received from a user. At step 204, each asset from amongst the plurality of assets is collated with the corresponding descriptor. At step 206, each asset from amongst the plurality of assets along with the corresponding descriptor is used for prompt tuning a Large Language Model (LLM). At step 208, augmentation of the corresponding descriptors of the plurality of assets is performed to generate additional descriptors for the plurality of assets. At step 210, embeddings are generated for each asset from amongst the plurality of assets, by employing the LLM, based on the corresponding descriptors of each asset from amongst the plurality of assets. At step 212, the generated embeddings of each asset from amongst the plurality of assets are indexed. At step 214, the database of assets is created by storing the generated embeddings in the indexed form for each asset from amongst the plurality of assets in the database.

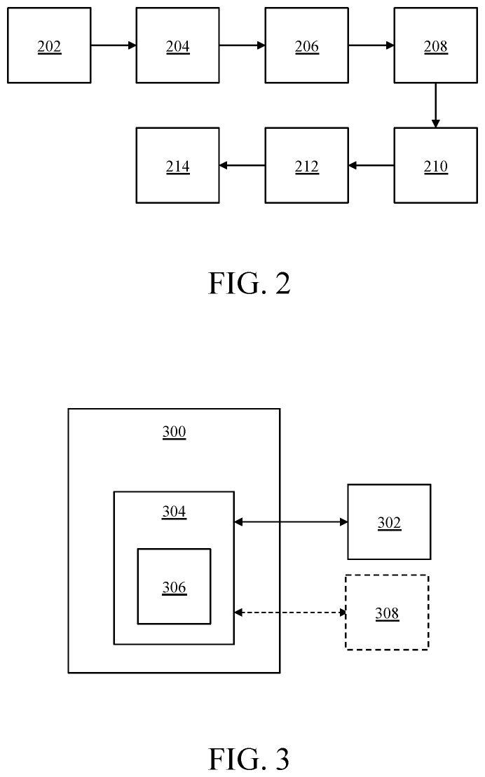

FIG. 3 is a block diagram for a system 300 for recommendation of suitable assets using a Large Language Model (LLM) 302, in accordance with an embodiment of the present disclosure. As shown in FIG. 3, the system 300 comprises a processor 304. The processor 304 is configured to receive descriptors for each asset from amongst a plurality of assets. Moreover, the processor 304 is configured to generate embeddings for each asset from amongst the plurality of assets, by employing the LLM 302, based on the provided descriptors of each asset from amongst the plurality of assets. Furthermore, the processor 304 is configured to create a database 306 of assets by storing the generated embeddings for each asset from amongst the plurality of assets in the database. Furthermore, the processor 304 is configured to receive a user query pertaining to a request for recommendation to solve an enterprise problem. Optionally, the user request is received from a user device 308 associated with the user. Furthermore, the processor 304 is configured to generate cosine similarity scores, wherein each cosine similarity score is generated between the user query and a corresponding generated embedding for a given asset stored in the database 306 of assets. Furthermore, the processor is configured to identify a predefined number of similar assets from amongst the database 306 of assets, based on highest cosine similarity scores. Furthermore, the processor 304 is configured to construct an optimal prompt based on the identified predefined number of similar assets and the user query. Furthermore, the processor 304 is further configured to prompt the LLM 302, using the constructed optimal prompt for generating a response as a recommendation of the identified predefined number of similar assets as the suitable assets for solving the user query.

Herein, the term processor 304 refers to a computational element that is operable to execute the software framework. Examples of the processor 304 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor 304 may refer to one or more individual processors, processing devices and various elements associated with a processing device that may be shared by other processing devices. Additionally, one or more individual processors, processing devices and elements are arranged in various architectures for responding to and processing the instructions that execute the software framework.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for recommendation of suitable assets using a Large Language Model (LLM) (202), the method comprising:
receiving descriptors for each asset from amongst a plurality of assets;
generating embeddings for each asset from amongst the plurality of assets, by employing the LLM, based on the provided descriptors of each asset from amongst the plurality of assets;
creating a database (206) of assets by storing the generated embeddings for each asset from amongst the plurality of assets in the database;
receiving a user query pertaining to a request for recommendation to solve an enterprise problem;
generating cosine similarity scores, wherein each cosine similarity score is generated between the user query and a corresponding generated embedding for a given asset stored in the database of assets;
identifying a predefined number of similar assets from amongst the database of assets, based on highest cosine similarity scores;
constructing an optimal prompt based on the identified predefined number of similar assets and the user query; and
prompting the LLM, using the constructed optimal prompt for generating a response as a recommendation of the identified predefined number of similar assets as the suitable assets for solving the user query.

2. The method according to claim 1, wherein the plurality of assets comprises at least one of: a machine learning model, a login module, a software, an object detection model, and the like.

3. The method according to claim 1, wherein the descriptors of each asset from amongst the plurality of assets comprises: an asset title, an asset description, asset metadata.

4. The method according to claim 1, wherein the LLM (202) used for implementing the step of generating embeddings for each asset from amongst the plurality of assets, is a text_embedding_ada model.

5. The method according to claim 1, wherein the generated embeddings for each asset from amongst the plurality of assets are stored in the database (206) in an indexed form.

6. The method according to claim 1, wherein the user query is received from a user device associated with a user.

7. The method according to claim 1, wherein the step of prompting the LLM (202), using the constructed optimal prompt, for recommending suitable assets for solving the enterprise problem, is implemented by using a technique of few-shot prompting.

8. A system (200) for recommendation of suitable assets using a Large Language Model (LLM) (202), the system comprising a processor (204) configured to:
receive descriptors for each asset from amongst a plurality of assets;
generate embeddings for each asset from amongst the plurality of assets, by employing the LLM, based on the provided descriptors of each asset from amongst the plurality of assets;
create a database (206) of assets by storing the generated embeddings for each asset from amongst the plurality of assets in the database;
receive a user query pertaining to a request for recommendation to solve an enterprise problem;
generate cosine similarity scores, wherein each cosine similarity score is generated between the user query and a corresponding generated embedding for a given asset stored in the database of assets;
identify a predefined number of similar assets from amongst the database of assets, based on highest cosine similarity scores;
construct an optimal prompt based on the identified predefined number of similar assets and the user query; and
prompt the LLM, using the constructed optimal prompt for generating a response as a recommendation of the identified predefined number of similar assets as the suitable assets for solving the user query.

9. The system (200) according to claim 8, wherein the plurality of assets comprises at least one of: a machine learning module, a login model, a software, an object detection model, and the like.

10. The system (200) according to claim 8, wherein the descriptors of each asset from amongst the plurality of assets comprises: an asset title, an asset description, an asset metadata.

11. The system (200) according to claim 8, wherein the LLM (202) used to generate embeddings for each asset from amongst the plurality of assets, is a text_embedding_ada model.

12. The system (200) according to claim 8, wherein the generated embeddings for each asset from amongst the plurality of assets are stored in the database (206) in an indexed form.

13. The system (200) according to claim 8, wherein the user query is received from a user device associated with a user.

14. The system (200) according to claim 9, wherein to prompt the LLM (202), using the constructed optimal prompt, to recommend the suitable assets for solving the enterprise problem, at least one processor (204) is configured to implement a technique of few-shot prompting.
